(19) United States
(12) Patent Application Publication
(10) Pub. No.: US 2022/0016764 A1
(43) Pub. Date: Jan. 20, 2022

(54) OBJECT GRASPING SYSTEM

(71) Applicant: Japan Cash Machine Co., Ltd., Osaka (JP)

(72) Inventors: Shuichi Yoshida, Osaka (JP); Takeshi Ohama, Osaka (JP); Keiho Imanishi, Kyoto (JP); Ryouichi Imanaka, Kyoto (JP)

(21) Appl. No.: 17/309,353

(22) PCT Filed: Oct. 16, 2019
(86) PCT No.: PCT/JP2019/040670

§ 371 Date: May 20, 2021

(51) Int. Cl. B25J 9/16; B25J 13/08

(52) U.S. Cl. CPC B25J 9/1612; B25J 9/1697; B25J 13/089; B25J 9/1653; B25J 9/1661

(57) ABSTRACT

There is provided an object grasping system (100) including a camera (150), a grasping unit (140), and a control unit (110) for moving the grasping unit (140) toward an object (200A) while repeatedly specifying a relative position of the object (200A) with respect to the grasping unit (140) based on an image taken by the camera (150).

### TECHNICAL FIELD

The present invention relates to a technique for object grasping systems for grasping and transporting cardboard boxes, bill storage boxes, and the like.

### BACKGROUND ART

Devices for grasping and transporting various objects are known in the art. For example, Japanese Translation of PCT International Application Publication No. 2018-504333 (Patent Literature 1) describes item grasping by a robot in an inventory system. According to Patent Literature 1, it is possible to utilize a robot arm or manipulator to grasp the inventory items in the inventory system. Information about an item to be grasped from one or more databases can be detected and/or accessed to determine a grasping strategy for grasping the item using a robotic arm or manipulator. For example, one or more accessed databases may include information about items, characteristics of items, and/or similar items, such as information indicating that grasping strategies have been valid or invalid for such items in the past.

### CITATION LIST

### Patent Literature

PTL 1: Japanese Translation of PCT International Application Publication No. 2018-504333

### SUMMARY OF INVENTION

### Technical Problem

An object of the present invention is to provide an object grasping system capable of grasping an object more efficiently.

### Solution to Problem

An object grasping system according to one aspect of the present invention includes a camera, a grasping unit, and a control unit for moving the grasping unit toward the object while specifying a relative position of the object with respect to the grasping unit based on an image taken by the camera, repeatedly.

### Advantageous Effects of Invention

As described above, the above aspect of the present invention provides an object grasping system capable of grasping an object more efficiently.

### BRIEF DESCRIPTION OF THE DRAWINGS

FIG. 1 is an image diagram showing an outline of an operation of an object grasping system 100 according to First Embodiment.

FIG. 2 is a block diagram of an object grasping system 100 according to First Embodiment.

FIG. 3 is a flowchart showing a processing procedure of the object grasping system 100 according to First Embodiment.

FIG. 4 is an image diagram showing an outline of the operation of the object grasping system 100 according to Second Embodiment.

FIG. 5 is an image diagram showing an outline of the operation of the object grasping system 100 according to Third Embodiment.

FIG. 6 is an image diagram showing the vicinity of the grasping portion 140 according to Fifth Embodiment.

FIG. 7 is a block diagram of an object grasping system 100 according to Fifth Embodiment.

FIG. 8 is a block diagram of an object grasping system 100 according to Sixth Embodiment.

FIG. 9 is a diagram for explaining a method of specifying an attitude of a CG object.

FIG. 10 is a block diagram of an object grasping system 100 according to Seventh Embodiment.

FIG. 11 is a flowchart showing a processing procedure of the object grasping system 100 according to Seventh Embodiment.

### DESCRIPTION OF EMBODIMENTS

Embodiments of the present invention are described below with reference to the accompanying drawings. In the following descriptions, like elements are given like reference numerals. Such like elements will be referred to by the same names, and have the same functions. Accordingly, detailed descriptions of such elements will not be repeated.

### First Embodiment

Overview of the overall configuration and operation of the object grasping system 100

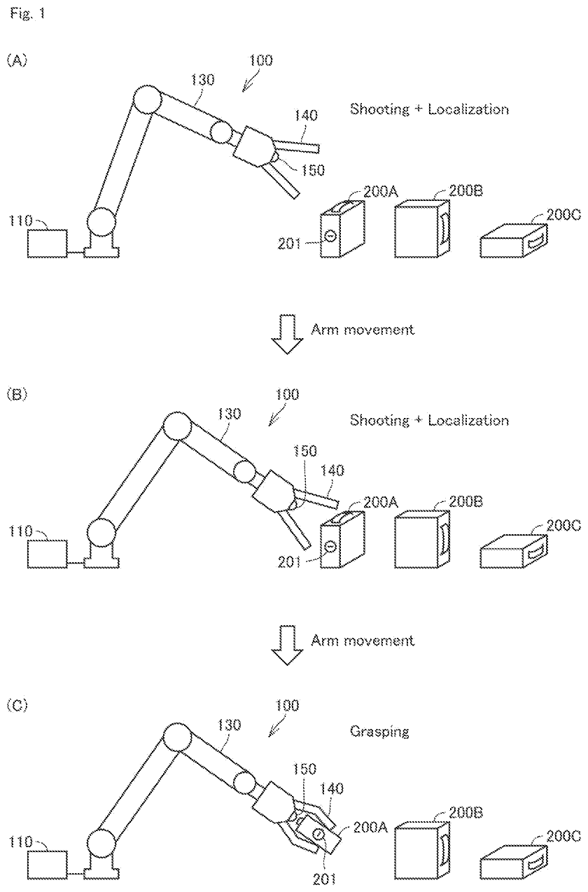

As shown in FIG. 1, the object grasping system 100 according to the present embodiment mainly includes an arm 130, a grasping unit 140, a camera 150, a controller 110 for controlling them, and the like.

Then, as shown in FIG. 1(A), the camera 150 captures the front of the arm 130. The controller 110 identifies the object 200A to be grasped next from among a plurality of objects 200A, 200B, 200C based on the captured images of the camera 150. In the present embodiment, the controller 110 detects each object 200A,200B,200C, based on various data relating to an object that has been learned. The controller 110 calculates the distance from the arm 130 or the grasping unit 140 to the respective object 200A,200B,200C to identify the object 200A disposed at a position closest to the arm 130 or the grasping unit 140. Reference numeral 201 denotes a key, in case that the object 200A has a cover, a key, or the like.

Regarding object detection, for example, machine learning technology represented by deep learning is used. The target object can be detected by using a model which has learned, as teacher data, the image of the target object and the 2D (two-dimensional) bounding box area including the region of the target object.

Further, regarding the method of estimating the distance, for example, by using an image (captured image) captured by the imaging device, 3D distance, from the imaging device to the target object, can be obtained based on the ratio occupied by the image area corresponding to the target object with respect to the entire image area.

This reduces the likelihood of obstacles being present between the arm 130 and the object and allows the object to be grasped smoothly.

As shown in FIG. 1(B), the controller 110 controls the arm 130 to move the grasping unit 140 toward the object 200A. In particular, in the present embodiment, the controller 110 repeats the calculation of the relative position of the object 200A with respect to the grip portion 140 by repeating the photographing by the camera 150 while moving the arm 130 and the grip portion 140, and repeats the calculation of the movement destination of the grip portion 140.

Regarding the estimation of the relative position, a three-dimensional distance from the camera 150 to the target object is acquires based on, for example, (1) the focal length of the camera 150, (2) in the image captured by the camera 150 by the focal length (captured image DPin), the ratio occupied of the image area corresponding to the target object with respect to the entire image area. The specification information of the target object, for example, the size of the target object, is known. And the focal length of the camera 150 when the captured image DPin is acquired is known. If the ratio occupied by the target object in the captured image DPin is known, it is possible to obtain a three-dimensional distance from the camera 150 to the target object. Therefore, such controller 110 for implementing 3D coordinate estimating unit can obtain a three-dimensional distance from the camera 150 to the target object, based on (1) the focal length of the camera 150, (2) in the image captured by the camera 150 by the focal length (captured image DPin), the ratio occupied of the image area corresponding to the target object with respect to the entire image area.

As shown in FIG. 1(C), when the grasping unit 140 reaches the vicinity of the object 200A, the controller 110 controls the posture and orientation of the grasping unit 140 based on the posture and orientation of the object 200A to sandwich the object by the grasping unit 140. In the present embodiment, the controller 110 controls the arm 130 and the grip 140 to grasp and lift an object, convey the object to a predetermined position, and place the object at the predetermined position.

As described above, the object grasping system 100 according to the present embodiment grasps and transports the object more reliably, by calculating the relative position and the relative posture of the object with respect to the grasping unit 140 and finely adjusting the position and the posture of the object based on the images sequentially acquired, while continuously taking pictures by the camera 150.

### Configuration of Object Grasping System 100

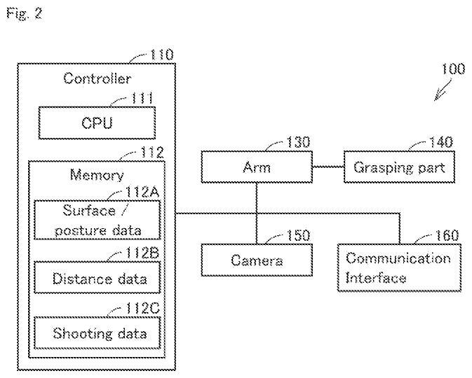

Next, the configuration of the object grasping system 100 according to the present embodiment will be described in detail. Referring to FIG. 2, the object grasping system 100 includes, as a primary configuration, a controller 110, an arm 130, a grasping unit 140, a camera 150, a communication interface 160, and the like.

The controller 110 controls each unit of the object grasping system 100. More particularly, controller 110 includes CPU 111, memory 112, and other modules. CPU 111 controls each portion of the object grasping system 100 based on programs and data stored in the memory 112.

In the present embodiment, the memory 112 stores data necessary for grasping an object, for example, a surface/orientation data 112A as learning data for specifying a surface or an orientation of an object, a distance data 112B as learning data for calculating a distance to an object, a photographing data 112C photographed by the camera 150, and data necessary for a grasping/carrying process according to the present embodiment.

The data structure and the method of creating the data necessary for the grasping and conveying process should not be restrictive. For example, an AI (Artificial Intelligence) or the like may be used to accumulate or create the data.

For example, the object grasping system 100 or other device can perform the following processing, as learning by the AI on the surface/posture data 112. Hereinafter, it is assumed that the rendering image Img1 is acquired by a rendering process in which a CG object grasped represented by CG (Computer Graphics) is projected and synthesized on the background image Img0. As shown in FIG. 9, when the CG object is a rectangular parallelepiped, when the CG object of 3D (three-dimensional) is projected converted into a 2D (two-dimensional), the visible surface includes three surfaces. Then, the class is set based on the combination of visible surfaces. For example, the position (orientation) of the CG object when the CG object is projected onto the background image Img0 is specified by the class number. For example, in FIG. 9, since visible surfaces on the background image Img0 (rendered image Img1) are the E surface as the upper surface, the A surface as the left side surface, and the B surface as the right side surface, this condition is set to “Class 1” as shown in FIG. 9, for example. By the number of classes set in this manner, it is possible to specify the orientation of the CG object when the CG object is projected onto the background image Img0. By doing so, for example, it is possible to create a more accurate surface and posture data 112A by generating a large number of learning data from, for example, rendered image Img1 related to various posture that are automatically created (an image in which a CG object is combined with a background image Img0), data for specifying a bounding box that defines a boundary of an image area surrounding a CG object, and data such as a class for specifying the posture of each CG object in the rendered image Img1.

The arm 130, based on an instruction from the controller 110, moves the grasping unit 140 to various positions, and directs the grasping unit 140 to various postures.

The grasping unit 140 sandwiches a target object and leaves the object based on an instruction from the controller 110.

The camera 150 captures a still image or a moving image based on an instruction from the controller 110 and passes the captured image data to the controller 110.

The communication interface 160 transmits data to a server or other device, and receives data from a server or other device, based on instructions from the controller 110.

### Operation of the Object Grasping System 100

Next, the object grasping process of the object grasping system 100 according to the present embodiment will be described. CPU 111 according to the present embodiment performs the object grasping process described below for the following objects based on the user's operation or automatically upon completion of the transport of the previous object.

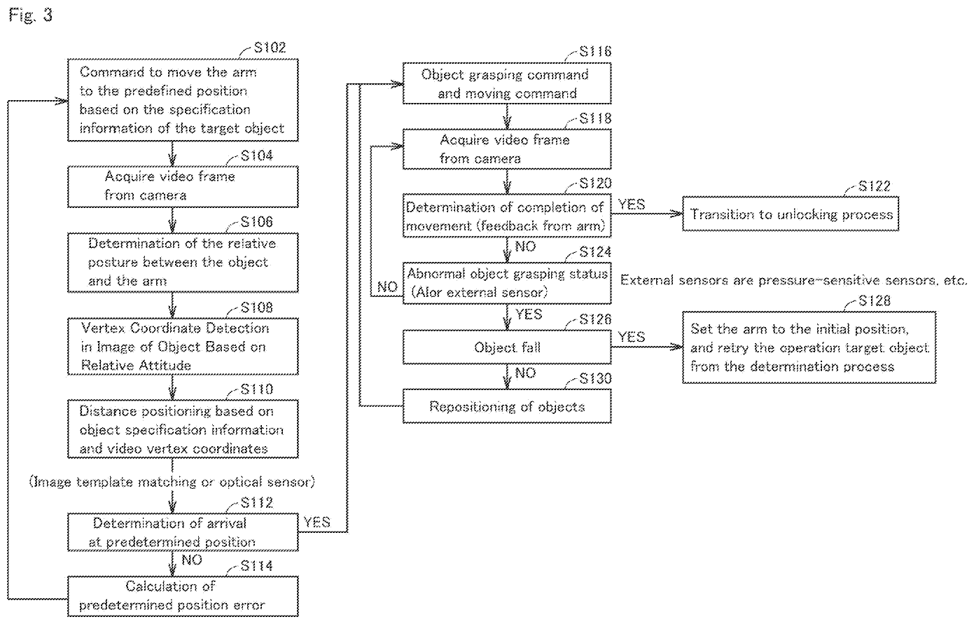

Referring to FIG. 3, first, CPU 111 controls the arm 130 based on specification information of a target object, for example, information of shapes, weights, colors, 3D design drawings, and the like, and moves the grasping unit 140 to a predetermined position where the object is sandwiched (step S102).

CPU 111 then causes the cameras 150 to take pictures. That is, CPU 111 acquires captured images from the cameras 150 (step S104).

CPU 111 calculates the relative posture of the target object with respect to the arm 130 and the grasping unit 140 based on the captured images (step S106). For example, CPU 111 identifies the posture and orientation of the object by performing a matching process with the captured images using the surface/posture data 112A of the memory 112 and the like.

CPU 111 identifies coordinates of vertices of the target object based on the relative postures of the target object with respect to the arm 130 and the grasping unit 140 (step S108).

CPU 111 calculates distances to the target object from the arm 130 and the grip unit 140 based on specifications of the target object and coordinates of vertices of the object (step S110). For example, CPU 111 identifies the distance to the object by comparing the captured image and the template image based on the template image included in the distance data 112B for measuring the distance.

Regarding the estimation of the relative position, for example, a three-dimensional distance from the camera 150 to the target object is acquired based on (1) the focal length of the camera 150, (2) in the image captured by the camera 150 by the focal length (captured image DPin), the occupied ratio of the image area corresponding to the target object with respect to the entire image area. The specification information of the target object, for example, the size is known. The focal length of the camera 150 when the captured image DPin is acquired is known. If the ratio occupied by the target object in the captured image DPin is known, it is possible to obtain a three-dimensional distance from the camera 150 to the target object. Therefore, such controller 110 for implementing 3D coordinate estimating unit can obtain a three-dimensional distance from the camera 150 to the target object, based on (1) the focal length of the camera 150, (2) in the image captured by the camera 150 by the focal length (captured image DPin), the ratio occupied by the image area corresponding to the target object for the entire image area.

CPU 111 determines whether the arm 130 and the grasping unit 140 have reached a distance within which the object can be gripped (step S112). If the arm 130 and the grasping unit 140 have not reached the range within which the object can be gripped (NO in step S112), CPU 111 calculates the error between the relative position of the object with respect to the grasping unit 140, which is scheduled in step S102, and the relative position of the object with respect to the actual grasping unit 140 (step S114), and moves the arm 130 to the predetermined position again (step S102).

When the arm 130 and the grasping unit 140 have reached the range within which the object can be gripped (YES in step S112), CPU 111 instructs the grasping unit 140 to grip the object and instructs the arm 130 to carry the object to a predetermined position (step S116).

CPU 111 transmits a shooting command to the cameras 150, and acquires the shot images (step S118). CPU 111 determines whether or not the object has been transported to the predetermined position based on the captured images (step S120). When the conveyance of the object to the predetermined position is completed (YES in step S120), CPU 111 instructs the grasping unit 140 to release the object. CPU 111, for example, causes the unlocking device to start the unlocking process such as the cover of the object, or causes another conveyance device to further convey the object, by using the communication interface 160. CPU 111 then returns the arm 130 to its original position and starts the process from step S102 for the next object.

If the transportation of the object to the predetermined position has not been completed (NO in step S120), CPU 111 determines whether or not there is an abnormality in the grasping of the object by the grasping unit 140 using an external sensor or the like based on the captured image (step S124). For example, it is preferable to train a model for detecting an abnormality in advance by using AI or the like. If there are no abnormalities in the grasping of the object by the grasping unit 140 (NO in step S124), CPU 111 repeats the process from step S118.

When there is an abnormality in the grasping of the object by the grasping unit 140 (YES in step S124), CPU 111 determines whether or not the object has fallen from the grasping unit 140 based on the captured images (step S126). When the object drops from the grasping unit 140 (YES in step S126), CPU 111 returns the arm 130 to the default position and repeats the process of determining the object (step S128).

If CPU 111 determines that the object has not fallen from the grasping unit 140 (YES in step S126), the process from step S116 is repeated.

### Second Embodiment

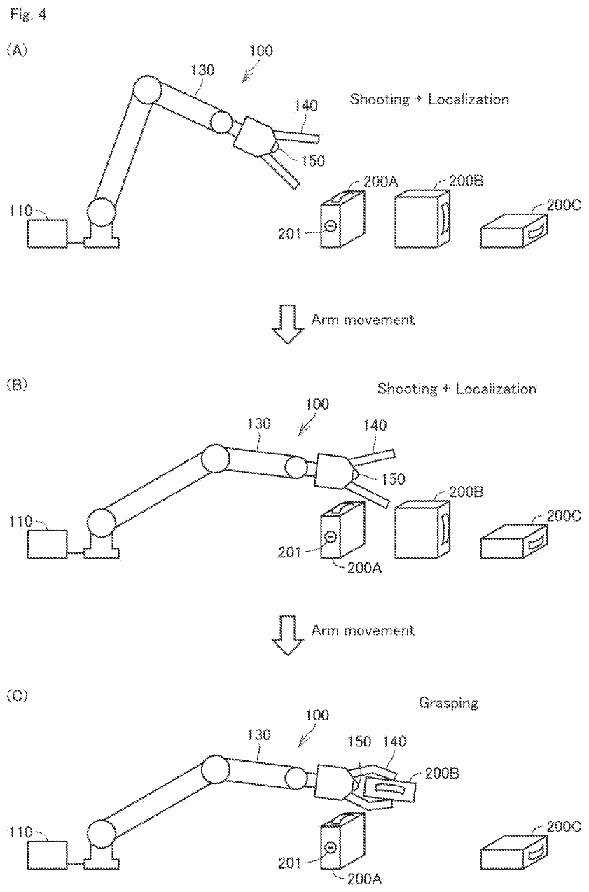

In the above embodiment, the objects are grasped and conveyed in order from the closest distance to the arm 130 and the grasping unit 140, but the present invention is not limited to such a configuration. For example, as shown in FIG. 4, it may be configured to grasp and carry sequentially from an object having a posture or orientation similar to the posture or orientation as an object after transportation.

More specifically, as shown in FIG. 4(A), the camera 150 photographs the front of the arm 130. The controller 110 identifies the object 200A to be grasped based on the captured images. In the present embodiment, the controller 110 detects the presence of the object 200A,200B,200C, calculates the relative posture of each object 200A,200B,200C with respect to the target posture after conveyance, and specifies the object 200B which has most similar posture to the posture after conveyance.

In particular, in the case where the object to be grasped has a key, a lid, or the like to be unlocked automatically thereafter, it is preferable to select the objects in order from the current posture of the face having the lid or the key similar to the posture of the face having the key or the lid after the object is transported. 201 refers to the key in that case.

As shown in FIG. 4(B), the controller 110 controls the arm 130 to move the grasping unit 140 toward the object 200B. In particular, in this embodiment, the controller 110 continues to calculate the relative position of the object 200B with respect to the grasping unit 140 by repeating photographing by the camera 150, and to move the arm 130 and the grasping unit 140.

As shown in FIG. 4(C), when the grasping unit 140 reaches the vicinity of the object 200B, the controller 110 controls the posture and the orientation of the grasping unit 140 based on the posture and the orientation of the object 200B to grasp and lift the object by the grasping unit 140. Then, the controller 110 places the object 200B in a target posture to the target position, and notifies the next device of the information via the communication interface 160. This allows, for example, the unlocking device to unlock the object 200B or remove the accommodation therein.

However, the grasping and conveying may be performed in order from an object having a posture or orientation close to the current posture or orientation of the grasping unit 140. That is, the controller 110 detects an object 200A,200B,200C, calculates a relative posture to the present posture of the grasping unit 140, and identifies an object 200B that is most similar to the posture of the grasping unit 140. As a result, it is possible to grasp the object without drastically changing the current posture of the grasping unit 140.

### Third Embodiment

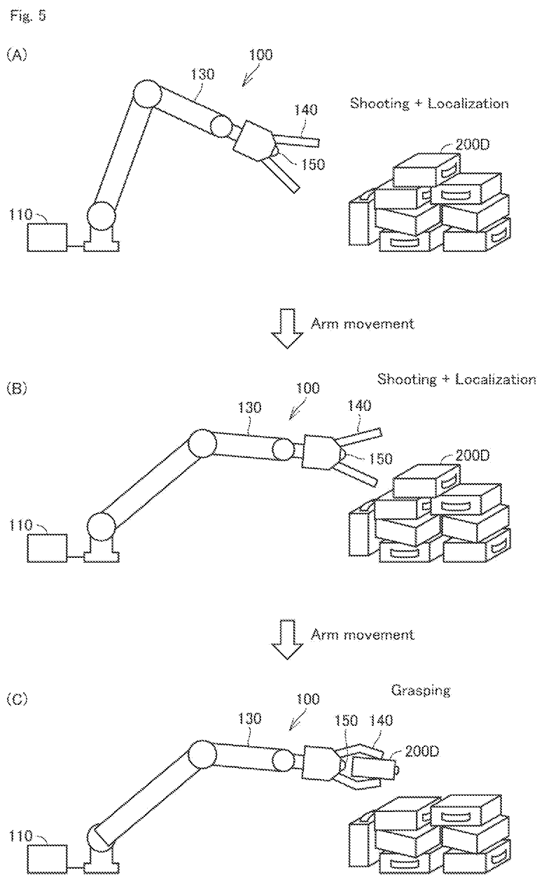

Alternatively, as shown in FIG. 5, the object grasping system 100 may be configured to grasp and convey the object in order from the object 200D arranged at the uppermost position among the objects superimposed on the predetermined areas.

More specifically, as shown in FIG. 5(A), the camera 150 photographs the front of the arm 130. The controller 110 identifies the object 200D to be grasped from the captured images. In the present embodiment, the controller 110 detects the presence of a plurality of objects, calculates the height of each of the plurality of objects, and specifies the object 200D at the highest position.

As shown in FIG. 5(B), the controller 110 controls the arm 130 to move the grasping unit 140 toward the object 200D. In particular, in the present embodiment, the controller 110 continuously calculates the relative position of the object 200D with respect to the grasping unit 140 by repeating the photographing by the camera 150, and moves the arm 130 and the grasping unit 140 to finely adjust the target point of the movement destination.

As shown in FIG. 5(C), when the grasping unit 140 reaches the vicinity of the object 200D, the controller 110 controls the posture and the orientation of the grasping unit 140 based on the posture and the orientation of the object 200D to grasp and lift the object by the grasping unit 140.

### Forth Embodiment

Alternatively, an object to be grasped next may be selected based on a plurality of factors such as the distance from the arm 130 or the grasping unit 140 to the object, the posture and orientation of the object, and the height. For example, the controller 110 may combine and score a plurality of elements, and grasp and convey objects in order from the highest scoring object to be grasped.

### Fifth Embodiment

In the above embodiment, in the step S124 or step S126 of FIG. 3, the controller 110, by utilizing the camera 150, determines whether or not grasping the object normally. However, the controller 110 may determine whether or not the object is normally grasped based on an image other than the image from the camera.

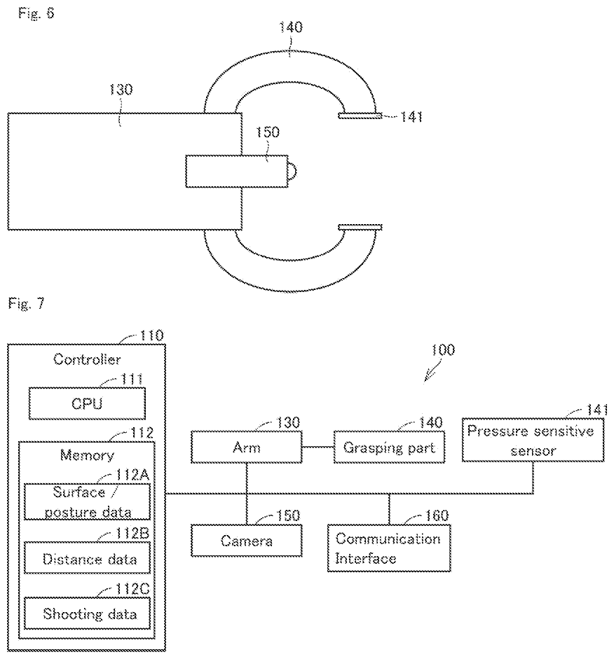

For example, as shown in FIGS. 6 and 7, the pressure-sensitive sensor 141 may be attached to the tip of the grasping unit 140. The controller 110 may determine whether or not grasping the object normally, based on the measured value of the pressure-sensitive sensor 141.

### Sixth Embodiment

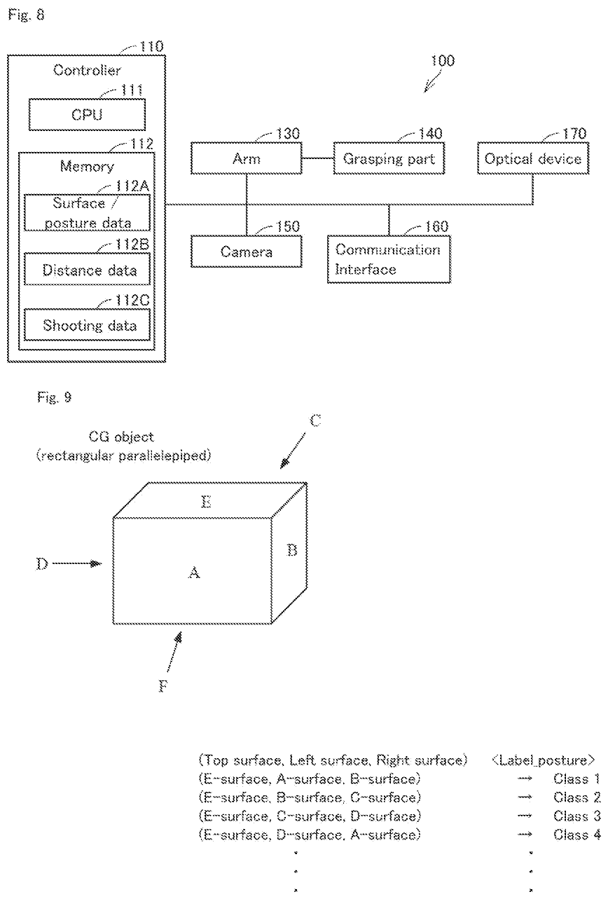

Further, in the above-described embodiment, in the step S110 of FIG. 3, the controller 110, based on the image from the camera 150, to calculate the surface, the posture, the distance, etc. of the object. However, the object grasping system 100 may be configured to calculate a surface, a posture, a distance, or the like of an object by utilizing other devices, such as, for example, an optical device 170 as shown in FIG. 8, a ranging sensor, an infrared sensor, or the like, in accordance with some or all of the above-described configurations, or in place of some or all of the above configurations.

### Seventh Embodiment

Further, in addition to the configuration of the above embodiment, it is preferable to grasp the object more accurately and quickly by using a wireless tag attached to the object. Specifically, the wireless tag attached to the object stores information for identifying the type of the object.

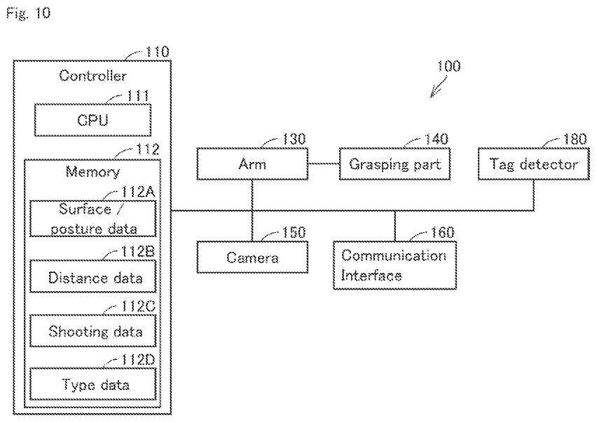

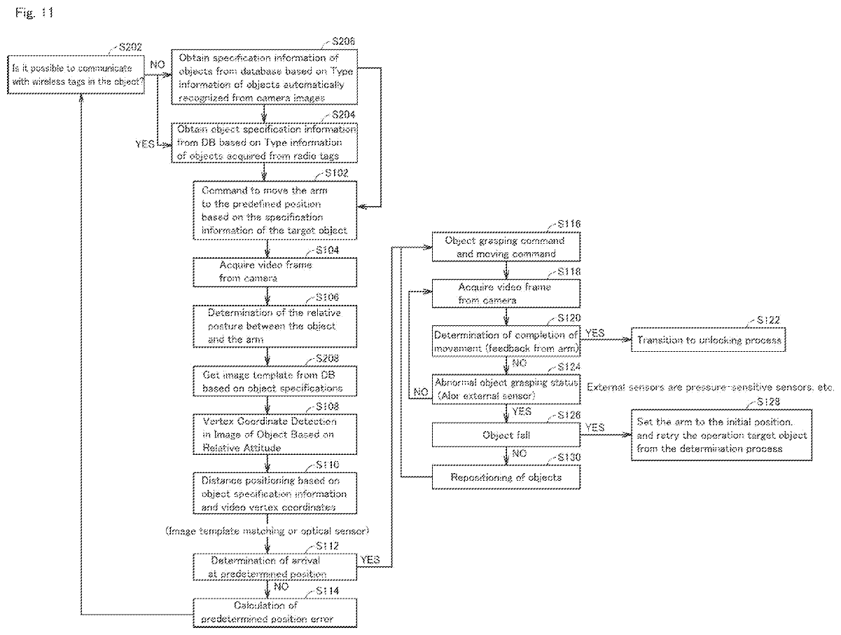

On the other hand, as shown in FIG. 10, the object grasping system 100 includes a tag detection unit 180 for acquiring information for specifying the type of the object by communicating with the wireless tag of the object. However, the controller 110 of the object grasping system 100 may acquire information for specifying the type of the object from an external device of the object grasping system 100 or the like.

The object grasping system 100 also stores type data 112D in a database. The type data 112D stores the specification information of an object in association with information for identifying the type of the object. The object grasping system 100 stores an image template for each specification information of an object in a database.

The object grasping process of the object grasping system 100 according to the present embodiment will be described. CPU 111 according to the present embodiment performs the object grasping process described below on the following objects based on the user's operation or automatically upon completion of the transport of the previous object.

Referring to FIG. 11, first, CPU 111 attempts to acquire the type information of the object from the radio tag of the target object through the tag detection unit 180 (step S202). When CPU 111 acquires the type information of the object (YES in the step S202), it refers to the database and specifies the specification information of the object (step S204).

On the other hand, when the type information of the object could not be obtained (NO in step S202), CPU 111 makes the camera 150 photograph the object, and specifies the specification information of the object using a technique such as automatic recognition by the AI based on the photographed image (step S206). In this case, CPU 111 may use the default object specification information.

CPU 111 controls the arm 130 to move the grasping unit 140 to a predetermined position where the object is sandwiched, based on specification information of the object, for example, information of shapes, weights, colors, 3D design drawings, and the like (step S102).

CPU 111 then causes the cameras 150 to take pictures. That is, CPU 111 acquires captured images from the camera 150 (step S104).

CPU 111 calculates the relative posture of the object with respect to the arm 130 and the grasping unit 140 based on the captured images (step S106). For example, CPU 111 identifies the posture and orientation of the object by performing a matching process with the captured images using the surface/posture data 112A of the memory 112 and the like.

In this embodiment, CPU 111 acquires the image template of the object from the database based on the specification information of the object identified by the step S204 or the step S206 (step S208). As described above, in the present embodiment, since CPU 111 can perform template matching according to the types and specifications of the objects, it becomes possible to more accurately and quickly specify the positions and the postures of the objects and the distances to the objects.

Since the process from the step S108 is the same as that of the above embodiment, the explanation will not be repeated here.

In the present embodiment, the object grasping system 100 specifies the type of the object to be targeted by communication with the wireless tag, and specifies the specification information of the object corresponding to the type of the object by referring to the database. However, the specification information of the object may be stored in the wireless tag, and the object grasping system 100 may directly acquire the specification information of the object by communicating with the wireless tag.

### Eighth Embodiment

In addition to the configuration of the above embodiment, the role of each device may be performed by another device. The role of one device may be shared by a plurality of devices. The role of a plurality of devices may be performed by one device. For example, a part or all of the role of the controller 110 may be performed by a server for controlling other devices such as an unlocking device and a transport device, or may be performed by a server on a cloud via the Internet.

Further, the grasping unit 140 is not limited to a configuration in which an object is sandwiched by two flat members facing each other, and may be a configuration in which an object is carried by a plurality of bone type frames, or an object is carried by being attracted by a magnet or the like.

### Overview

In the above-described embodiment, there is provided an object grasping system including a camera, a grasping unit, and a control unit (controller) for moving the grasping unit toward the object while repeatedly specifying a relative position of the object with respect to the grasping unit based on an image taken by the camera.

Preferably, when a plurality of target objects can be detected, the control unit selects a target object close to the grasping unit and moves the grasping unit toward the selected target object.

Preferably, when a plurality of target objects can be detected, the control unit selects the next target object to be grasped based on the posture of each target object, and moves the grasping unit toward the selected next target object.

Preferably, the control unit selects a target object close to the posture of the grip unit or a target object close to the posture of the target object after conveyance, based on the posture of each of the target objects.

Preferably, when a plurality of target objects can be detected, the control unit specifies a surface having a key of each of target objects, and selects a target object to be grasped next based on the direction of the surface having the key.

Preferably, when a plurality of target objects can be detected, the control unit selects the uppermost target object and moves the grasping unit toward the selected target object.

Preferably, the object grasping system further includes a detection unit for detecting the wireless tag. The control unit specifies the specification of the target object based on information from the wireless tag attached to the target object by using the detection unit, and specifies the relative position of the target object with respect to the grasping unit based on the specification.

In the above-described embodiment, there is provided an object grasping method for grasping a target object. The method includes repeating the steps of, photographing with a camera, specifying a relative position of the target object with respect to the grasping unit based on the photographed image, and moving the grasping unit toward the target object.

The embodiments disclosed herein are to be considered in all aspects only as illustrative and not restrictive. The scope of the present invention is to be determined by the scope of the appended claims, not by the foregoing descriptions, and the invention is intended to cover all modifications falling within the equivalent meaning and scope of the claims set forth below.

### Reference Signs List

100: object grasping system
110: controller
111: CPU
112: memory
112A: surface and posture data
112B: distance Data
112C: shooting data
130: arm
140: grasping part
141: pressure sensitive sensor
150: camera
160: communication Interface
200A: object
200B: object
200C: object
200D: object
   1-8. (canceled)

9. An object grasping system, comprising:
a camera;
a grasping unit; and
a control unit for moving the grasping unit toward the object while repeatedly specifying a relative position of the object with respect to the grasping unit based on an image taken by the camera.

10. The object grasping system according to claim 9, wherein the control unit selects an object close to the grasping unit and moves the grasping unit toward the selected object, when a plurality of the target objects can be detected.

11. The object grasping system according to claim 9, wherein the control unit selects an object to be grasped next based on the posture of each of the objects and moves the grasping unit toward the selected object, when a plurality of the target objects are detected.

12. The object grasping system according to claim 11, wherein the control unit selects the object close to the orientation of the grasping unit or the object close to the orientation of the target after conveyance based on the orientation of the object.

13. The object grasping system according to claim 11, wherein the control unit specifies a surface having a key of each of the objects and selects an object to be grasped next based on the direction of the surface having the key, when a plurality of the objects are detected.

14. The object grasping system according to claim 9, wherein the control unit selects an uppermost object and moves the grasping unit toward the selected object, when a plurality of the target objects are detected.

15. The object grasping system according to claim 9, further comprising:
a detection unit for detecting a wireless tag,
wherein the control unit identifies a specification of the object based on information from the wireless tag attached to the object by using the detection unit, and identifies a relative position of the object with respect to the grasping unit based on the specification.

16. The object grasping system according to claim 10, further comprising:
a detection unit for detecting a wireless tag,
wherein the control unit identifies a specification of the object based on information from the wireless tag attached to the object by using the detection unit, and identifies a relative position of the object with respect to the grasping unit based on the specification.

17. The object grasping system according to claim 11, further comprising:
a detection unit for detecting a wireless tag,
wherein the control unit identifies a specification of the object based on information from the wireless tag attached to the object by using the detection unit, and identifies a relative position of the object with respect to the grasping unit based on the specification.

18. The object grasping system according to claim 12, further comprising:
a detection unit for detecting a wireless tag,
wherein the control unit identifies a specification of the object based on information from the wireless tag attached to the object by using the detection unit, and identifies a relative position of the object with respect to the grasping unit based on the specification.

19. The object grasping system according to claim 13, further comprising:
a detection unit for detecting a wireless tag,
wherein the control unit identifies a specification of the object based on information from the wireless tag attached to the object by using the detection unit, and identifies a relative position of the object with respect to the grasping unit based on the specification.

20. The object grasping system according to claim 14, further comprising:
a detection unit for detecting a wireless tag,
wherein the control unit identifies a specification of the object based on information from the wireless tag attached to the object by using the detection unit, and identifies a relative position of the object with respect to the grasping unit based on the specification.

21. An object grasping method, comprising:
shooting with the camera;
identifying the relative position of the object with respect to the grasping portion based on the captured image;
moving the grasping portion toward the target object; and
grasping the object by repeating the above steps.

22. The object grasping method according to claim 21, further comprising via the control unit selecting an object close to the grasping unit and moving the grasping unit toward the selected object, when a plurality of the target objects can be detected.

23. The object grasping method according to claim 21 further comprising via the control unit selecting an object to be grasped next based on the posture of each of the objects and moving the grasping unit toward the selected object, when a plurality of the target objects are detected.

24. The object grasping method according to claim 23, further comprising via the control unit selecting the object close to the orientation of the grasping unit or the object close to the orientation of the target after conveyance based on the orientation of the object.

25. The object grasping method according to claim 23, further comprising via the control unit specifying a surface having a key of each of the objects and selecting an object to be grasped next based on the direction of the surface having the key, when a plurality of the objects are detected.

26. The object grasping method according to claim 21, further comprising via the control unit selecting an uppermost object and moving the grasping unit toward the selected object, when a plurality of the target objects are detected.

27. The object grasping method according to claim 21, further comprising:
detecting a wireless tag via the detection unit;
via the control unit identifying a specification of the object based on information from the wireless tag attached to the object by using the detection unit, and identifying a relative position of the object with respect to the grasping unit based on the specification.

28. The object grasping method according to claim 24, further comprising:
detecting a wireless tag via the detection unit;
via the control unit identifying a specification of the object based on information from the wireless tag attached to the object by using the detection unit, and identifying a relative position of the object with respect to the grasping unit based on the specification.
